(19) United States
(12) Patent Application Publication
(10) Pub. No.: US 2009/0209889 A1
(43) Pub. Date: Aug. 20, 2009

(54) Massage Cushion

(76) Inventor: Da-Xiao LI, HuluDao City (CN)

Correspondence Address: Dr. BANGER SHIA, 102 Lindencrest Ct., Sugar Land, TX, 77479-5201, US

(21) Appl. No.: 12/032,653

(22) Filed: Feb. 16, 2008

(51) Int. Cl. A61H 7/00

(52) U.S. Cl. 601/134

(57) ABSTRACT

A massage cushion comprises: a cushion body and a plurality of protrusions formed on the cushion body. The protrusions are arranged transversely and longitudinally to form a plurality of transverse and longitudinal rows, and these rows of protrusions form a rectangle, a distance between the transverse rows of the protrusions is equal to that between the longitudinal rows of the protrusions. When the user lies on the massage cushion, the user's acupressure points will be massaged and stimulated by the protrusions, and thus can promote blood circulation.

### BACKGROUND OF THE INVENTION

1. Field of the Invention

The present invention relates to health care products, and more particularly to a massage cushion provided with a plurality of arrays of protrusions.

2. Description of the Prior Art

At present, the effect of most of the health care cushion products on the market is usually not obvious. Among them, there is a massage cushion which is specially designed to massage the acupressure points of the user's body. If the user does not exactly know the location of the acupressure points, the acupressure points cannot be massaged efficiently.

In order to make sure the user lying on the massage cushion can have the right acupressure points massaged, the user must be taught to know the right locations of the acupressure points, or it has to make an exclusive massage cushion which is specially for each user. Otherwise, the user is hard to have the right acupressure points massaged.

The present invention has arisen to mitigate and/or obviate the afore-described disadvantages.

### SUMMARY OF THE INVENTION

The primary objective of the present invention is to provide a massage cushion which utilizes rectangularly arranged protrusions to massage acupressure points of the user's body stochastically.

In order to achieve the abovementioned objective, the massage cushion comprises a cushion body and a plurality of protrusions. The protrusions are formed on the cushion body. The protrusions are arranged transversely and longitudinally to form a plurality of rows, and these rows form a rectangle, and a distance between the transverse rows of the protrusions is equal to that between the longitudinal rows of the protrusions.

When the user lies on the massage cushion, since the protrusions are arranged equidistantly to form a rectangle, the acupressure points of the user can be massaged stochastically. Even if the user does not know the locations of the acupressure points, acupressure points of the user's body can be massaged and stimulated stochastically.

### BRIEF DESCRIPTION OF THE DRAWINGS

FIG. 1 is a perspective view of a massage cushion in accordance with an embodiment of the present invention;

FIG. 2 is a side view of the FIG. 1;

FIG. 3 is a view showing that the user lies on the massage cushion in accordance with the embodiment of the present invention;

FIG. 4 is a view showing that the top of the each protrusion is formed with an arc concave surface in accordance with the embodiment of the present invention; and

FIG. 5 is a view showing that the protrusions are cone-shaped in accordance with the embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

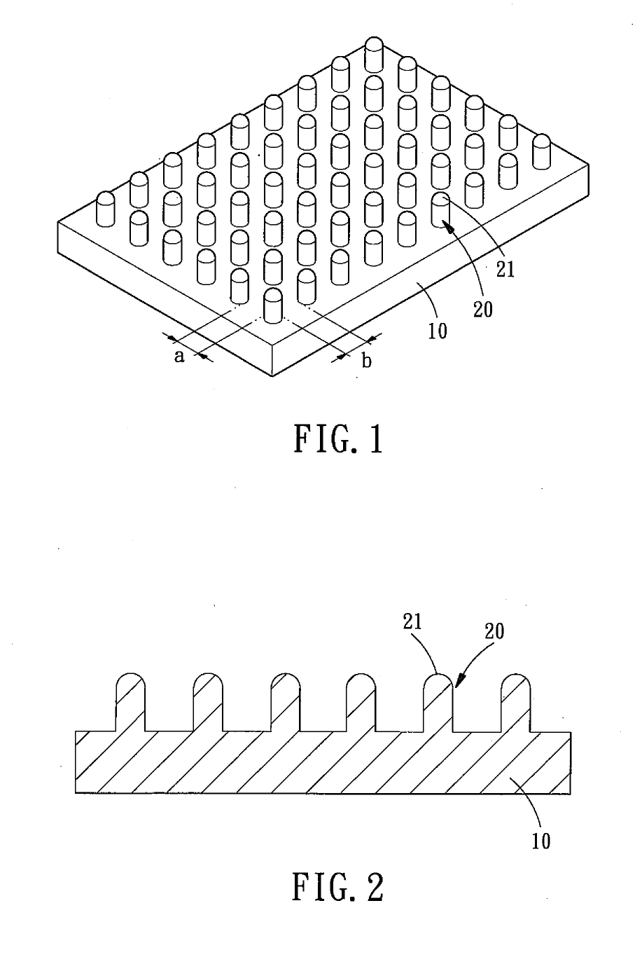

An embodiment of a massage cushion in accordance with the present invention is shown in FIGS. 1 and 2 and comprises: a cushion body 10 and a plurality of protrusions 20.

The cushion body 10 is plate-shaped and is made of resilient plastic material. In this embodiment, the cushion body 10 is 80 cm long, 40 cm wide and 0.4 cm thick.

The protrusions 20 are made of resilient plastic material and are formed on the cushion body 10. These protrusions 20 are arranged transversely and longitudinally to form a plurality of transverse and longitudinal rows, and these rows of protrusions 20 form a rectangle. A distance a between the transverse rows of the protrusions 20 is equal to that b between the longitudinal rows of the protrusions 20. In this embodiment, there are forty-two protrusions 20, and they are arranged in such a manner that every six protrusions 20 are arranged in a transverse row and every seven protrusions 20 are arranged in a longitudinal row to form a rectangle, and the distance a and the distance b are 1.4 cm long. A height of the each protrusion 20 is 0.8 cm.

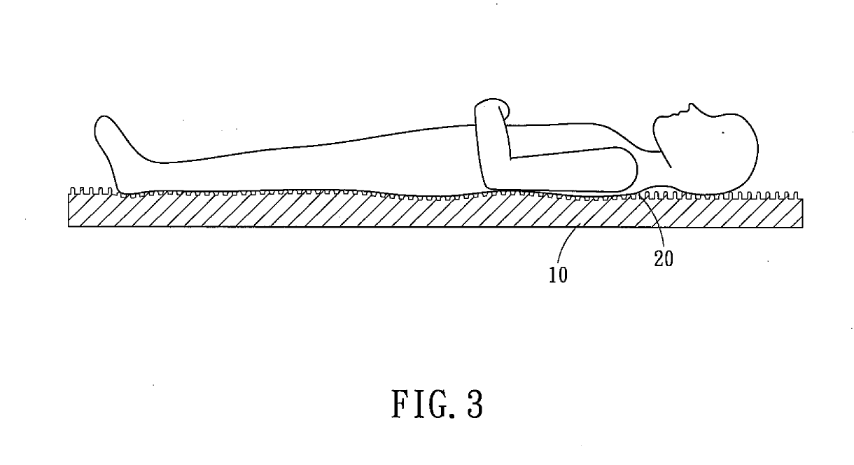

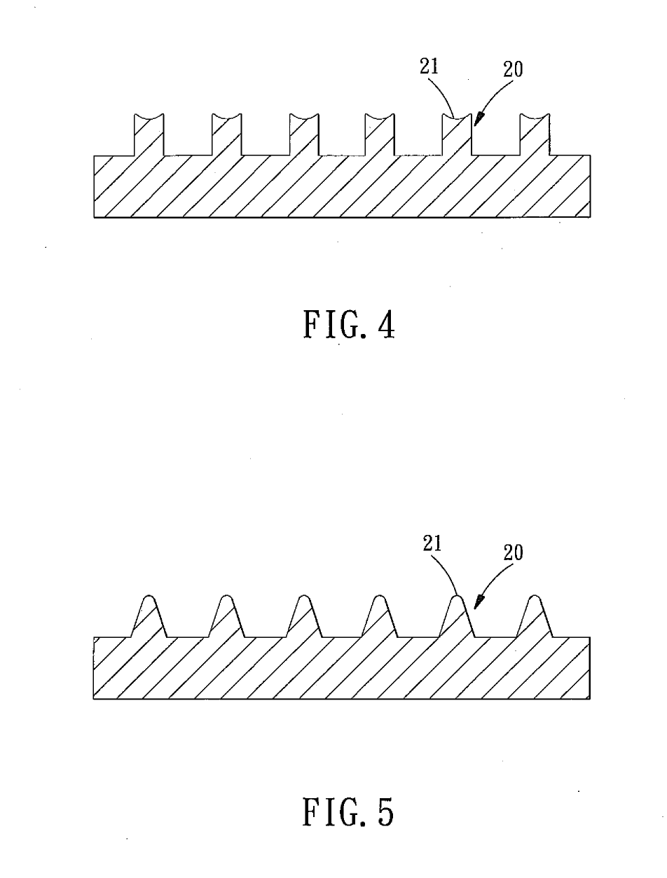

When a user lies on the massage cushion 10 as shown in FIG. 3, the user's neck, backside, waist and hip can press on the protrusions 20, and thus can be massaged by the protrusions 20. Acupressure points of these body portions can also be massaged and stimulated by the protrusions 20 stochastically to promote the user's health.

The cushion body 10 can be formed as one piece with the protrusions 20 so as to simplify the producing process and save the cost.

The protrusions 20, as shown in FIGS. 1 and 2, can be column-shaped and have a diameter of 0.6 cm, and a top 21 of each protrusion 20 is formed with an arc concave surface. Thus the user can feel more comfortably when massaged by the protrusions 20.

The protrusions 20, as shown in FIG. 5, can be cone-shaped, and the top 21 of each protrusion 20 is formed with an arc convex surface.

While we have shown and described various embodiments in accordance with the present invention, it is clear to those skilled in the art that further embodiments may be made without departing from the scope of the present invention.

What is claimed is:

1. A massage cushion comprising:
a cushion body; and
a plurality of protrusions being formed on the cushion body and arranged transversely and longitudinally to form a plurality of transverse and longitudinal rows, and these rows of protrusions forming a rectangle, a distance between the transverse rows of the protrusions being equal to that between the longitudinal rows of the protrusions.

2. The massage cushion as claimed in claim 1, wherein each protrusion is column-shaped, and a top of each protrusion is formed with an arc convex surface.

3. The massage cushion as claimed in claim 1, wherein each protrusion has a diameter of 0.6 cm.

4. The massage cushion as claimed in claim 1, wherein each protrusion is column-shaped, and a top of each protrusion is formed with an arc concave surface.

5. The massage cushion as claimed in claim 1, wherein a diameter of each protrusion is 0.6 cm.

6. The massage cushion as claimed in claim 1, wherein each protrusion is cone-shaped, and a top of each protrusion is formed with an arc convex surface.

7. The massage cushion as claimed in claim 1, wherein the cushion body is 80 cm long, 40 cm wide and 0.4 cm thick.

8. The massage cushion as claimed in claim 1, wherein there are forty-two protrusions, the forty-two protrusions are arranged in such a manner every six protrusions are arranged in a transverse row and seven protrusions are arranged in a longitudinal row to form a rectangle, and the distance between the transverse rows of the protrusions and the distance between the longitudinal rows of the protrusions are 1.4 cm.

9. The massage cushion as claimed in claim 1, wherein a height of each protrusion is 0.8 cm.

10. The massage cushion as claimed in claim 1, wherein the cushion body is formed as one piece with the protrusions.
